(19) United States
(12) Patent Application Publication
(10) Pub. No.: US 2025/0250507 A1
(43) Pub. Date: Aug. 7, 2025

(54) LAUNDRY DETERGENT COMPOSITION

(71) Applicant: Tufco, L.P., Los Angeles, CA (US)

(72) Inventors: Shahram Roozrokh, Hauppauge, NY (US); Egal Gabbay, Los Angeles, CA (US)

(21) Appl. No.: 18/908,385

(22) Filed: Oct. 7, 2024

Related U.S. Application Data
(63) Continuation-in-part of application No. 18/433,255, filed on Feb. 5, 2024, now Pat. No. 12,110,476.

(51) Int. Cl. C11D 1/29; C11D 1/22; C11D 1/655; C11D 1/72; C11D 1/83; C11D 3/10; C11D 3/20; C11D 3/33; C11D 3/37; C11D 3/386; C11D 3/43; C11D 17/04

(52) U.S. Cl. CPC C11D 1/29; C11D 1/22; C11D 1/655; C11D 1/721; C11D 1/83; C11D 3/10; C11D 3/2086; C11D 3/33; C11D 3/3723; C11D 3/38618; C11D 3/38636; C11D 3/43; C11D 17/043; C11D 2111/12

(57) ABSTRACT

A composition for use in a laundry pouch comprises four primary surfactants, a secondary surfactant, and three enzymes. The primary surfactants may be two anionic surfactants and two nonionic surfactants. The secondary surfactant may be nonionic. The composition may be used in a pouch or added as a liquid detergent to a laundry wash. The composition may include chelators, color, fragrance, solvents, surfactant boosters, whiteners and other ingredients.

### RELATED APPLICATIONS

This patent is a continuation-in-art of U.S. application Ser. No. 18/433,255, filed Feb. 5, 2024, U.S. Pat. No. 12,110,476, entitled LAUNDRY DETERGENT COMPOSITION, the contents of which are incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD

This disclosure relates to sealed, single-dose water soluble laundry detergent pouches and the laundry detergents contained therein.

### DESCRIPTION OF THE RELATED ART

Laundry soaps and detergents are a necessity of modern life, and there is a wide array of such products available to meet different consumer preferences and needs. The soaps and detergents may be configured to work best in certain types of washing machines, for example, and may comprise ingredients and concentrations thereof which take into account such factors as level of soiling, wash temperature, and the like.

Laundry soaps may be available in the form of a liquid or powder detergent, or as pouches which contain, usually in concentrated amounts, the laundry detergent. The terms soap or detergent should be understood as comprising a liquid or a solid composition.

Liquid detergent may enter the washing machine tub or drum with the water, while pouches may be placed in the machine and dissolved by the water. Pouches have several benefits over liquid detergent, including the possible concentrated formula noted, which requires less space and quantity. Other advantages include the capability for precise doses of liquid detergent which can be premeasured and sealed in the pouch, as well as easier and less messy handling and transportation.

Laundry detergents in pouches may also offer the usual options of liquid detergent, including whether the detergents are scented or unscented. This is a personal consumer choice, some preferring a non-scented laundry wash while others may prefer the inclusion in the detergent of a scent or fragrance. Amongst the latter group, the choices are considerable, and many detergents will incorporate a scent which has a certain fragrance or smell. The pouches can be configured to contain the detergent so that a variety of fragrances may be available.

Temperatures in a washing machine may vary, and typically may be selected by the user. Typical washing machines either allow the user to select a specific temperature (often available in increments such as ten degrees) or have relative temperature options usually designated as hot, warm, cool and cold. These settings correspond to a temperature of water which is introduced into the washing machine's wash tub. Hot is generally 54C to 60C. Warm is generally between 32C to 49C. Cold is generally between 15C to 30C. The pouches are manufactured so that the pouch or outer container will dissolve in water within the wide range of temperatures normally used in a washing machine.

### DETAILED DESCRIPTION

The laundry detergent compositions described herein may be added directly to a washing machine or may be contained in a pouch. The laundry detergent composition may comprise a composition having at its essence a combination of surfactants and enzymes. A particularly good formulation has been found using a combination of four primary surfactants, and specifically two anionic surfactants and two nonionic surfactants, along with a smaller amount of a third nonionic surfactant.

The pouch is water soluble, such that it will dissolve during operation of a washing machine, and may be a film made of polyvinyl alcohol (PVA) or a derivative of PVA. The film may be adapted to be soluble in cold water. The pouch may be biodegradable, and may include a variety of components. The pouch may comprise components which are inert in the washing machine, and may include active components. The pouch may include fragrance, such as free fragrance and/or encapsulated fragrance.

The term single-dose means sufficient laundry detergent composition contained in the pouch for one load of laundry. The dose may vary based upon the size of the load. The dose may correlate to a full load for a standard size washing machine, although the dose may be set for a partial load, such as one-half or three quarters, or for an extra large load.

The four primary surfactants may be sodium laureth sulfate, linear alkylbenzene sulfonic acid, ethoxylated alcohol, and fatty alcohol polyoxyethylene ether. Sodium laureth sulfate and linear alkylbenzene sulfonic acid are anionic. Ethoxylated alcohol and fatty alcohol polyoxyethylene ether are nonionic. The sodium laureth sulfate may comprise 25% to 40% by weight of the composition, such as 29%, 30%, 31%, 32%, 33%, 34%. The linear alkylbenzene sulfonic acid may be present in an amount of 5% to 20% by weight, such as 6%, 7%, 10%, 12.4%., 13%, 15%, 17.4%. The ethoxylated alcohol may comprise 5% to 30% by weight of the composition. The ethoxylated alcohol may be ethoxylated tridecyl alcohol present in an amount of 5% to 30% by weight, such as 6%, 7%, 10%, 13%, 15%, 17.4%, 18%. The fatty alcohol polyoxyethylene ether may comprise 10% to 30% by weight of the composition, such as 12%, 15%, 20%, 21%, 22%, 23%, 24%, 25%.

The fifth surfactant, which is nonionic, may be cocamide monoethanolamine. The fifth surfactant may be 0.2% to 1% by weight, such as 0.25%, 0.46%, 0.67%.

The enzymes may include a proteolysis catalyst, a catalyst of starch hydrolysis, and a hydrolyzer of complex polysaccharides. Enzymes may be selected from one or more of a protease, an amylase and a mannanase. Each of the enzymes may be present in the amount of 0.5% to 3% by weight of the composition, such as 1.5%, 1.6%, 1.7%, 1.8%, 1.9% protease, such as 1.5%, 1.6%, 1.7%, 1.8%, 1.9% amylase, and 0.5%, 1.0%, 1.5%, 2.0%, 2.5%, 3.0% mannanase.

The laundry detergent composition may include a brightener. The brightener may comprise disodium distyrylbiphenyl sulfonate. The disodium distyrylbiphenyl sulfonate may be present in the laundry detergent composition in the amount of 0.5% to 3% by weight, such as 0.5%, 0.7%, 0.9%, 1.0%, 1.2%, 1.4%, 1.5%, 1.6%, 1.8%, 2.3%.

The laundry detergent composition may include a chelator/chelating agent to facilitate the softening of the water. The chelator may include tetrasodium glutamate diacetate, and may be present in an amount by weight such as 0.05% to 2.0% by weight, such as 0.12%, 0.17%, 0.2% or 0.7%, 1.2%, 1.8%. The chelator may include sodium citrate, and may be present in an amount of 1% to 4% by weight, such as 0.7%, 0.9%, 1.0%, 1.2%, 2.0%, 2.5%, 3.0%, 3.5%, 4.0%. The chelator may include tetrasodium iminodisuccinate, and may be present in an amount of 3% to 12% by weight, such as 3%, 4.5%, 4.8%, 5.0%, 6.0%, 7.0%, 7.5%, 8.0%, 9.0%. The chelator may include trisodium dicarboxymethyl alaninate, and may be present in an amount of 1% to 10% by weight, such as 1.5.0%,1. 6.0%, 2.7.0%, 2.8.0%, 9.0%.

The laundry detergent composition may include one or more coloring agents in trace amounts.

The laundry detergent composition may include a fabric softener, such as cationic polyethylene.

The laundry detergent composition may include fragrance. The fragrance may comprise many different compounds chosen for their suitability to provide the fragrance desired in a particular configuration of laundry detergent. The fragrance may have one or more of several scents, and such fragrance may be present in an amount sufficient to impart to the laundry detergent composition and the laundry wash the desired scent or scents. The fragrance may be present as a liquid in the amount of 0.1% to 1.5% by weight, such as 0.3%, 0.5%, 0.7%, 1.4%. The fragrance may take the form of beads, such as those described in U.S. application Ser. No. 18/521,377, U.S. Pat. No. 12,084,634, which is incorporated herein by reference.

The laundry detergent composition may include an oxidant for fabric whitening purposes. The whitening agent may be or include percarbonate sodium 0.005% to 6% by weight, such as 0.1%, 1.5%, 2.0%, 2.5%, 3.0%, 3.5%, 4.0%, 4.5%. The percarbonate sodium may be sodium carbonate peroxide solution 20%. The whitening agent may be or include sodium borate, and which is present in the amount 0.05% to 2% by weight, such as 0.12%, 0.17%, 0.2% or 0.7%, 1.2%, 1.8%.

The laundry detergent composition may include a pH adjuster which may include citric acid. The citric acid, when used, may be present in an amount of 0.5% to 3.5% by weight, such as 0.9%, 1.0%, 1.1%, 1.2%, 1.5%, 1.7%, 2.4%, 2.8%.

The laundry detergent composition may include a preservative. The preservative may be methylchloroisothiazolinone and/or methylisothiazolinone present in the amount of 0.005% to 0.9%, such as 0.005%, 0.007%, 0.009%.

The laundry detergent composition may include a soap such as but not limited to monoethanolamine. The monoethanolamine may be present in an amount of 0.5% to 5% by weight, such as 2.0%, 2.5%, 2.9%, 4.3%, 4.8%.

The laundry detergent composition may include a solvent. The solvent may include propylene glycol, and this solvent may be present in the amount of 3% to 12% by weight, such as 3%, 4%, 4.5%, 7.5%, 8.0%, 8.4%, 9%, 9.5%, 11%. The solvent may include ethanol in the amount of 1.5% to 5% by weight, such as 1.8%, 1.9%, 2.0%, 2.5%, 2.6%, 3.0%, 3.5%, 4.0%. The solvent may include glycerin present in the amount of 1.5% to 5% by weight, such as 1.8%, 1.9%, 2.0%, 2.5%, 2.6%, 3.0%, 3.5%, 4.0%.

The laundry detergent composition may include an enzyme stabilizer. The stabilizer may be calcium chloride present in the amount of 0.01% to 0.03%, such as 0.018%, 0.019%, 0.02%, 0.026%, 0.030%.

The laundry detergent composition may include a stain remover. The stain remover may include trisodium salt of methylglycinediacetic acid in the amount of 1.5% to 5% by weight, such as 1.8%, 1.9%, 2.0%, 2.5%, 2.8%, 3.0%, 3.5%, 4.0%.

The laundry detergent composition may include a surfactant booster. The surfactant booster may be a cationic polyethylene, such as ethoxylated polyethyleneimine and may be present in an amount of 2% to 10% by weight, such as 3%, 3.2%, 4.0% 4.5%, 4.8%, 5%, 5.5%, 6%, 6.5%, 8%. Ethoxylated polyethyleneimine is also a stain removal agent of bleachable and clay stains.

The laundry detergent composition may include a thickener. The thickener may be sodium carboxymethylcellulose, such as Cekol 700, or hydroxyethyl cellulose, present in the amount of 0.1% to 0.3%, such as 0.20%.

The laundry detergent composition may have one or more coloring agents. The coloring agents may be selected to obtain a specific color or quality of appearance.

The pouch containing the laundry detergent composition may define two or more compartments. The compartments may contain identical formulations or may have different formulations. For example, the formulations of the compartments may be functionally identical, but with different colors or fragrances. Some ingredients or combinations of ingredients may interfere with one another or engender aesthetics which are desirably addressed on a more individualized basis. For example, oxidants can interfere with enzymes, so the oxidants and enzymes may be disposed in separate compartments.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A product comprising a laundry detergent composition which consists essentially of:
a first anionic surfactant;
a second anionic surfactant different from the first anionic surfactant;
a first nonionic surfactant;
a second nonionic surfactant different from the first nonionic surfactant;
a third nonionic surfactant different from the first nonionic surfactant and the second nonionic surfactant;
0.5% to 3% a proteolysis catalyst;
0.5% to 3% a catalyst of starch hydrolysis;
0.5% to 3% a hydrolyzer of complex polysaccharides.

2. The product of claim 1 wherein the first anionic surfactant is sodium laureth sulfate, the second anionic surfactant is linear alkylbenzene sulfonic acid; the first nonionic surfactant is ethoxylated alcohol, the second nonionic surfactant is fatty alcohol polyoxyethylene ether, and the third nonionic surfactant is cocamide monoethanolamine.

3. The product of claim 1 wherein the first anionic surfactant is 25% to 40% by weight, the second anionic surfactant is 5% to 20% by weight; the first nonionic surfactant is 2% to 20% by weight, the second nonionic surfactant is 17% to 30% by weight, and the third nonionic surfactant is 0.2% to 1% by weight.

4. The product of claim 1 wherein the proteolysis catalyst is a protease enzyme.

5. The product of claim 1 wherein the catalyst of starch hydrolysis is an amylase enzyme.

6. The product of claim 1 wherein the hydrolyzer of complex polysaccharides is a mannanase enzyme.

7. The product of claim 1 wherein the additional ingredient is the brightener which comprises disodium distyrylbiphenyl disulfonate present in the composition in an amount of 0.5% to 3%.

8. The product of claim 1 further comprising three different chelating agents.

9. The product of claim 8 wherein the chelating agents are tetrasodium glutamate diacetate 0.05% to 2.0% by weight, sodium citrate 3% to 12% by weight, and tetrasodium iminodisuccinate 1% to 10% by weight.

10. The product of claim 1 further comprising two different oxidants which comprise percarbonate sodium present in the composition in an amount of 2% to 8% by weight and sodium borate present in the amount 0.05% to 2% by weight.

11. The product of claim 1 further comprising a pH adjuster which comprises citric acid present in the composition in the amount of 0.5% to 3.5% by weight.

12. The product of claim 1 further comprising a soap in the form of monoethanolamine present in the composition in an amount of 0.1% to 3% by weight.

13. The product of claim 1 further comprising three different solvents comprising propylene glycol 3% to 12% by weight, ethanol 1.5% to 5% by weight, and glycerin 1.5% to 5% by weight.

14. The product of claim 1 further comprising a surfactant booster which comprises ethoxylated polyethyleneimine 2% to 10% by weight.

15. The product of claim 1 comprising a sealed, single-dose water soluble pouch containing the laundry composition.
